(19) United States
(12) Patent Application Publication
(10) Pub. No.: US 2014/0347577 A1
(43) Pub. Date: Nov. 27, 2014

(54) TOUCH PANEL

(71) Applicant: WINTEK CORPORATION, Taichung City (TW)

(72) Inventors: Chia-Chi Chen, Taichung City (TW); Kuo-Chang Su, Taichung City (TW); Siang-Lin Huang, Taichung City (TW)

(73) Assignee: WINTEK CORPORATION, Taichung City (TW)

(21) Appl. No.: 14/285,608

(22) Filed: May 22, 2014

(30) Foreign Application Priority Data
May 24, 2013 (TW) 102118346
Nov. 8, 2013 (TW) 102140711

(51) Int. Cl. G06F 1/16

(52) U.S. Cl. CPC G06F 1/1601; G06F 1/1643
USPC 349/12

(57) ABSTRACT

A touch panel, having a light transmission touch sensing region and a peripheral region adjacent to at least one side of the touch sensing region, includes a decoration layer, a hole-filling layer, an outer frame layer, and a touch sensing element. The decoration layer is disposed in the peripheral region and has at least one function hole. The hole-filling layer includes a first portion disposed at the function hole and a second portion overlapping at least one portion of the decoration layer. The outer frame layer is disposed in the peripheral region and partially overlaps the second portion of the hole-filling layer. The touch sensing element is disposed in the light transmission touch sensing region.

### BACKGROUND OF THE INVENTION

1. Field of the Invention

The present invention relates to a touch panel, and more particularly, to a touch panel in which the height differences between films or layers are smaller.

2. Description of the Prior Art

Since touch panels provide human-machine interaction, they have been widely applied to smart phones, global positioning navigator systems (GPS navigator system), tablet personal computers, personal digital assistants (PDA), laptop personal computers, and other electronic devices.

In the case of the conventional one-glass solution (OGS) touch panel, the major elements of the touch panel and the decoration layer are fabricated on a large glass substrate and then the glass substrate is cut into small pieces. Finally a thicker shielding layer (such as an ink layer) is formed on the surfaces of the small cut glass substrate to prevent leakage of light from the outer side of the glass substrate. However, the height differences between the ink layer formed last as described above and the other films or layers fabricated earlier on the surface of the glass substrate are not small enough such that it is detrimental to the subsequent bonding process, prone to bubbles and affecting product yield.

### SUMMARY OF THE INVENTION

One of the primary objectives of the present invention is to provide a touch panel having a hole-filling layer fabricated before or after the outer frame layer to form step-shaped structure. For example, the hole-filling layer may serve as a ladder between the outer frame layer and other films and layers to reduce the height differences among layers on the surface of the substrate to improve the yield of the subsequent bonding process.

To achieve the above objective, the present invention introduces a touch panel that has a light transmission touch sensing region and a peripheral region adjacent to at least one side of the light transmission touch sensing region. The touch panel includes a decoration layer, a hole-filling layer, an outer frame layer and at least one touch sensing element. The decoration layer is disposed in the peripheral region and includes at least one function hole. The hole-filling layer includes a first portion and a second portion. The first portion is disposed at the function hole. The second portion overlaps at least one portion of the decoration layer. The outer frame layer is disposed in the peripheral region and partially overlaps the second portion of the hole-filling layer. The touch sensing element is disposed in the light transmission touch sensing region.

To achieve the above objective, the present invention further provides a touch panel that has a light transmission touch sensing region and a peripheral region adjacent to at least one side of the light transmission touch sensing region. The touch panel includes a decoration layer, a hole-filling layer, an outer frame layer and at least one touch sensing element. The decoration layer is disposed in the peripheral region and includes at least one function hole. The hole-filling layer includes a first portion and a second portion. The first portion is disposed at the function hole. The second portion overlaps at least one portion of the decoration layer. The outer frame layer is disposed in the peripheral region and at least partially overlaps the second portion of the decoration layer, and the outer frame layer is disposed between the second portion of the hole-filling layer and the decoration layer in the vertical projection direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the top view of a touch panel according to the first embodiment of the present invention.

FIG. 2 is a schematic diagram of the cross-sectional view of a touch panel shown in FIG. 1 along the sectional line A-A′ and sectional line B-B′.

FIG. 3 is a schematic diagram of the cross-sectional view of a touch panel according to the first variant embodiment of the first embodiment of the present invention.

FIG. 4 is a schematic diagram of the cross-sectional view of a touch panel according to the second variant embodiment of the first embodiment of the present invention.

FIG. 5 is a schematic diagram of the partial cross-sectional view of a touch panel according to the second embodiment of the present invention.

FIG. 6 is a schematic diagram of the cross-sectional view of a touch panel according to a variant embodiment of the second embodiment of the present invention.

FIG. 7 is a schematic diagram of the top view of a touch panel according to the third embodiment of the present invention.

FIG. 8 is a schematic diagram of the cross-sectional view of a touch panel shown in FIG. 7 along the sectional line C-C′ and sectional line D-D′.

FIG. 9 is a schematic diagram of the partial cross-sectional view of a touch panel according to the fourth embodiment of the present invention.

FIG. 10 is a schematic diagram of the partial cross-sectional view of a touch panel according to the fifth embodiment of the present invention.

FIG. 11 is a schematic diagram of the partial cross-sectional view of a touch panel according to the sixth embodiment of the present invention.

FIG. 12 is a schematic diagram of the partial cross-sectional view of a touch panel according to the seventh embodiment of the present invention.

FIG. 13 is a schematic diagram of the partial cross-sectional view of a touch panel according to the eighth embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate on the contents and effects to be achieved.

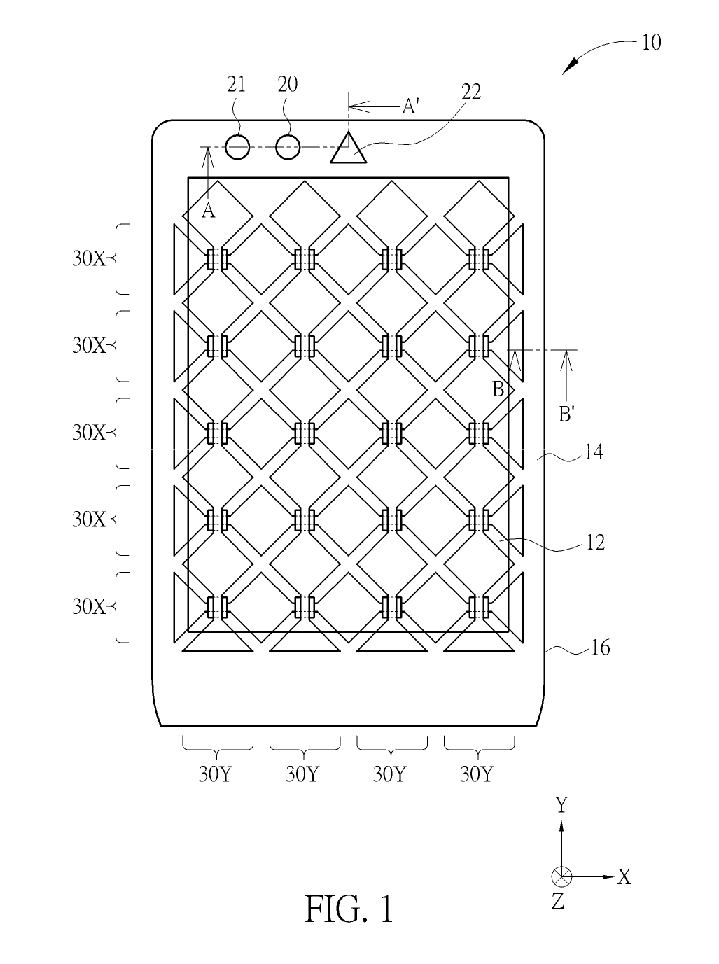

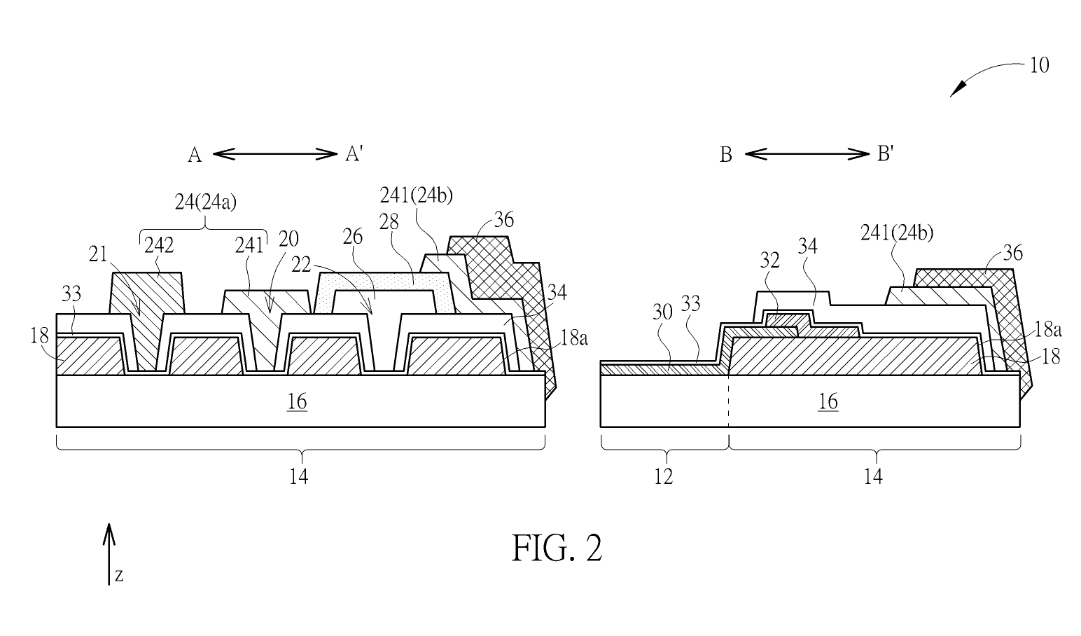

Referring to FIG. 1 and FIG. 2, FIG. 1 is a schematic diagram of the top view of a touch panel according to the first embodiment of the present invention, and FIG. 2 is a schematic diagram of the cross-sectional view of the touch panel shown in FIG. 1 along the sectional line A-A′ and the sectional line B-B′, wherein FIG. 1 only shows partial elements of the touch panel of the present invention. For convenience of explanation, all the figures of the present invention are only schematic in order to explain the present invention more easily. The detail and actual size proportion of the touch panel may be adjusted according to practical design requirements. As shown in FIG. 1 and FIG. 2, the touch panel 10 according to the first embodiment of the present invention includes a light transmission touch sensing region 12 and a peripheral region 14. The peripheral region 14 is disposed on at least one side of the light transmission touch sensing region 12. The peripheral region 14 in this embodiment surrounds the light transmission touch sensing region 12, but not limited thereto. According to different requirements, the peripheral region 14 may only be adjacent to a portion of the edges of the light transmission touch sensing region 12. Also, the peripheral region 14 may optionally include touch sensing electrodes (not shown in the figure), but still be categorized as the peripheral region 14, which is explained here first. The touch panel 10 according to this embodiment is an OGS type touch panel. It includes a substrate 16 and the films or layers and touch sensing elements disposed on the surface of the substrate 16, but not limited thereto. The present invention may be applied to other types of touch panels, and the related description will be explained later. The substrate 16 may be a glass substrate, a plastic substrate, or a flexible substrate. The materials of the flexible substrate for example may be a polyethylene terephthalate (PET) film. At least one touch sensing element 30 is disposed in the light transmission touch sensing region 12, including the first axial electrodes 30X extending along the horizontal direction X in FIG. 1 and the second axial electrodes 30Y extending along the vertical direction Y in FIG. 1, wherein the first axial electrodes 30X and the second axial electrodes 30Y are crossly disposed and are isolated from each other. It is noteworthy that the shapes of all the touch sensing electrodes of the first axial electrodes 30X and the second axial electrodes 30Y may be designed according to the requirements, such as diamond electrodes and polygonal electrodes, but not limited thereto. The touch sensing element 30 may include transparent conductive materials, such as indium tin oxide, indium zinc oxide, nano silver, carbon nanotubes, graphene, and conductive polymer. In other embodiments, the touch sensing electrodes included in the touch sensing element 30 may be a plurality of triangle touch sensing electrodes disposed reversely side by side, or a plurality of rectangular touch sensing electrodes disposed separately from each other. However, the present invention is not limited to the above description. Other regular-shaped or irregular-snapped touch sensing electrodes may be used according to the design requirements for being distributed evenly in the light transmission touch sensing region 12. For example, the touch sensing element 30 may include a plurality of strip touch sensing electrodes and a plurality of pad touch sensing electrodes disposed between two adjacent strip touch sensing electrodes so as to obtain the desired effect of touch-sensing detection.

The touch panel 10 includes a decoration layer 18 disposed on the surface of the substrate 16 in the peripheral region 14. The decoration layer 18 has at least one opening hole to be used as a function hole of the touch panel 10. In this embodiment, the decoration layer 18 includes a first function hole 20, a second function hole 21 and a third function hole 22. For example, the first function hole 20 serves as an infrared sensor hole, hereinafter referred to as the IR hole. The second function hole 21 serves as a light transmission hole of a light emitting diode, hereinafter referred to as LED hole. And the third function hole 22 is regarded as a logo (or logotype) hole which includes the logo or the trademark of the product, but not limited thereto. The third function hole 22 may be the function key hole positioned at the bottom part of the peripheral region 14, such as a return key, in another embodiment. The touch panel 10 optionally includes a surface layer 26 and a back cover layer 28 disposed at the third function hole 22 sequentially from bottom to top, wherein the third function hole 22 is filled with the surface layer 26. For example, the surface layer 26 includes light-transmissible or opaque ink material. Its color is metallic silver or other colors that make the logo more significant. The back cover layer 28 includes opaque ink material. However, the back cover layer 28 may be omitted as needed, such as the situation that the surface layer 26 is light-transmissible material or does not need to be protected. In addition, the touch panel 10 further includes at least one hole-filling layer 24. In this embodiment, the portion of the hole-filling layer 24 disposed at the function holes 20, 21 is defined as the first portion 24a of the hole-filling layer 24, and the portion of the hole-filling layer 24 disposed in the outer part of the peripheral region 14, such as the right side of the schematic diagram of the cross-sectional view of the touch panel along the sectional line A-A′ and the right side of the schematic diagram of the cross-sectional view of the touch panel along the sectional line B-B′, is defined as the second portion 24b. In this embodiment, the hole-filling layer 24 includes a first hole-filling layer 241 and a second hole-filling layer 242 to fill the first function hole 20 and the second function hole 21 respectively. Since the first function hole 20 and the second function hole 21 in this embodiment are used as the IR hole and the LED hole respectively, the first hole-filling layer 241 preferably include the material allowing infrared light to penetrate but not allowing visual light to pass through (called as infrared transmission material), or to include the light-transmissible material only permitting lights with specific wavelength to penetrate. Specifically, the materials mentioned above which allows the infrared to penetrate but does not allow visual light through, for example, may allow more than 75% of the infrared to pass through but only allow lower than 20% of the lights with other wavelength to pass through, but not limited thereto. The second hole-filling layer 242 may include the material which is transparent but not conductive, but not limited thereto. As a result, the first hole-filling layer 241 and the second hole-filling layer 242 may include transparent or semi-transparent material, and both of them have different functions. In other embodiments, the touch panel 10 may only have the first function hole 20 and the third function hole 22. For example, the first function hole 20 is used as the IR hole or the LED hole, and the touch panel 10 only includes one of the first hole-filling layer 241 and the second hole-filling layer 242.

Moreover, in the outer part of the peripheral region 14, the first hole-filling layer 241 partially overlaps the surface layer 26, the back cover layer 28, and the decoration layer 18 in the vertical projection direction Z, and it also overlaps the outer sidewall 18a of the decoration layer 18. Namely a portion of the surface layer 26 and a portion of the back cover layer 28 are disposed between the decoration layer 18 and the second portion 24b of the hole-filling layer 24, and a portion of the back cover layer 28 is disposed between the surface layer 26 and the second portion 24b of the hole-filling layer 24. In this embodiment, the touch panel 10 optionally includes a first function layer 33 and a second function layer 34. The first function layer 33 in this embodiment fully overlaps the substrate 16, including the first, the second and the third function holes 20, 21, 22. The material of the first function layer 33 may be inorganic material. For example, the first function layer 33 may be a composite layer of silicon dioxide and nitrogen oxide. However, it may include only one of the above materials in different embodiments. The first function layer 33 may be regarded as an optical matching layer to improve the overall visual effect of the touch panel 10, for example, by reducing the significance of the touch sensing element 30 in the light transmission touch sensing region 12. The portion of the second function layer 34 close to the outer edge of the substrate 16 is disposed between the decoration layer 18 and the first hole-filling layer 241 and partially overlaps the decoration layer 18. The second function layer 34 also overlaps the sidewalls of the first, the second and the third function holes 20, 21, 22. The second function layer 34 may include organic or inorganic material. For example, the second function layer 34 of this embodiment includes organic material. In this embodiment, the second function layer 34 has a hollow rectangular pattern or a frame-shaped pattern. Therefore, it is only disposed in the outer part of the peripheral region 14, and partially covers the decoration layer 18 and overlaps the outer sidewall 18a of the decoration layer 18 in the vertical project direction Z. In addition, the second function layer 34 is partially overlapped by the second portion 24b of the hole-filling layer 24. However, the shape of the second function layer 34 is not limited to the frame-shaped pattern in this embodiment. The first function layer 33 and the second function layer 34 may provide protection for the touch panel 10 to be used as a protection layer. In other embodiments, the first and the second function layers 33, 34 may be omitted or only one of the above two function layers is included.

Please refer to the schematic diagram of the cross-sectional view along the sectional line B-B′. The touch sensing element 30 is disposed in the light transmission touch sensing region 12, and a portion of the touch sensing element 30 extends from the light transmission touch sensing region 12 to the peripheral region 14 and partially overlaps the surface of the decoration layer 18. On the surface of the decoration layer 18, a wire 32 is further disposed and electrically connected to the touch sensing element 30 on the decoration layer 18. In this embodiment, the first function layer 33 fully overlaps the touch sensing element 30, the wire 32, and the majority of the elements disposed on the substrate 16, and therefore it can protect the touch sensing element 30, the wire 32 and the elements it overlaps. Moreover, the touch panel 10 in this embodiment further includes an outer frame layer 36 disposed in the outer part of the peripheral region 14, namely in the portion near the outer edge of the surface of the substrate 16. In addition, the outer frame layer 36 is disposed on the first hole-filling layer 241, and form a step-shaped structure, namely a ladder-like structure, with the first hole-filling layer 241 (the second portion 24b of the hole-filling layer 24). As shown in FIG. 2, the outer frame layer 36 and the first hole-filling layer (241) (the second portion 24b of the hole-filling layer 24) partially overlap each other, and the second portion 24b of the hole-filling layer 24 is disposed between the outer frame layer 36 and the decoration layer 18 in the vertical projection direction Z. The outer frame layer 36 may include light-shading material. For example, the decoration layer 18 and the outer frame layer 36 in this embodiment both include material (s) with higher optical density (OD), such as black ink, and the decoration layer 18 and the outer frame layer 36 may include the same material (s), such that only a layer of the decoration layer 18 and a layer of the outer frame layer 36 are needed, but not limited thereto. They may also include black photoresist material and black ink material respectively, but the colors are not limited thereto. In addition, in other embodiments which are not illustrated, the outer frame layer 36 may extend inwardly from the outer edge of the peripheral region 14 to the inner edge of the peripheral region 14.

As shown in FIG. 2, the second portion 24b of the hole-filling layer 24 is directly contact with the surface of the second function layer 34 and the surface of the back cover layer 28 and at least partially overlaps the back cover layer 28, the second function layer 34 and the decoration layer 18 in this embodiment. The second portion 24b of the hole-filling layer 24 is disposed between the back cover layer 28 and the outer frame layer 36 and between the surface layer 26 and the outer frame layer 36, and it is also disposed between the decoration layer 18 and the outer frame layer 36. Therefore, the surface of the second portion 24b of the hole-filling layer 24 becomes the bridge between the surface of the back cover layer 28 and the surface of the outer frame layer 36 so that the cross-sectional profile of the outer part of the peripheral region 14 of the touch panel 10 has more gradual stepped gradient, which improves the yield of the subsequent bonding processes and restrains the bubble occurrence. Besides, since some materials of the hole-filling layer 24 allows light with only specific wavelength to pass through, the second portion 24b of the hole-filling layer 24 can provide the light-shading effect for the outer side and outer edge of the peripheral region 14. According to the present invention, the steps of the fabrication process of the touch panel 10, for example but not limited to, includes forming the decoration layer 18 on a substrate with a large size first, then forming the touch sensing element 30 and the wire 32 in order, forming the first function layer 33 and the second function layer 34 to overlap the wire 32 and the touch sensing element 30, and then forming the surface layer 26 to fill in the third function hole 22 and the back cover layer 28 that overlaps the surface layer 26. Furthermore, the hole-filling layer 24 is formed, for example, first fabricating the second hole-filling layer 242 to fill into the second function hole 21, and then fabricating the first hole-filling layer 241 to fill into the first function hole 20, wherein the portion of the first hole-filling layer 241 in the outer part of the peripheral region 14 overlaps the decoration layer 18, the first function layer 33, the second function layer 34, and the back cover layer 28. Finally, the substrate with large size is cut into small-sized substrates 16 with the expected size of the touch panel 10, and then the outer frame layer 36 is formed on the second portion 24b of the hole-filling layer 24, but not limited thereto. In other embodiments, the process of cutting the large-sized substrate can also be performed before carrying out any process after the formation of the touch sensing element 30, the decoration layer 18 or the wire 32. It is noteworthy that the order of the forming processes of the first hole-filling layer 241 and the second hole-filling layer 242 mentioned above can be exchanged, and it should not be restricted to that the surface layer 26 and the back cover layer 28 are fabricated only after the formation of the second function layer 34 is finished. In addition, the decoration layer 18, the surface layer 26, the back cover layer 28, the first hole-filling layer 241, the second hole-filling layer 242, and the outer frame layer 36 may be fabricated by screen printing, offset printing, inkjet or coating method, but not limited thereto. It is known from the above that in this embodiment a process is carried out to form the first portion 24a (the first hole-filling layer 241) and the second portion 24b of the hole-filling layer 24 before fabricating the outer frame layer 36 to make the surface of the outer part of the peripheral region 14 of the touch panel 10 have gentler gradient. It should be noted that in other embodiments the second portion 24b is not needed to partially overlap the back cover layer 28 and can only solely overlap the top of decoration layer 18. In addition, the second portion 24b should not be limited to be formed only in the outer part of the peripheral region 14. For example, if the outer frame layer 36 extends inwardly from the outer edge of the peripheral region 14 to the inner edge of the peripheral region 14, the second portion 24b may also be further disposed in the inner part of the peripheral region 14 to make the touch panel 10 have a gentler surface in the inner part of the peripheral region 14 through forming a step-shaped structure or a ladder with the outer frame layer 36 and the second portion 24b. Furthermore, if all the elements and every film or layer of the touch panel 10 is directly fabricated on the surface of the cut substrate 16 with small size of the end product, the fabrication of the outer frame layer 36 can be omitted, and the decoration layer 18 can directly overlap and extend to the outer part and outer side of the peripheral region 14 instead.

It is noteworthy that in different embodiments the surface layer 26 or the back cover layer 28 mentioned above can also be regarded as the hole-filling layers of the present invention, such as first forming the first hole-filling layer 241, then forming the back cover layer 28 to make the back cover layer 28 overlap the outer part of the first hole-filling layer 241 in the vertical projection direction Z, and then forming the outer frame layer 36 on the surface of the back cover layer 28.

The touch panel of the present invention is not limited by the aforementioned embodiment, and may have other different preferred embodiments and variant embodiments. To simplify the description, the identical components in each of the following embodiments and variant embodiments are marked with identical symbols. For making it easier to compare the difference between the embodiments and variant embodiments, the following description will detail the dissimilarities among different embodiments and variant embodiments and the identical features will not be redundantly described.

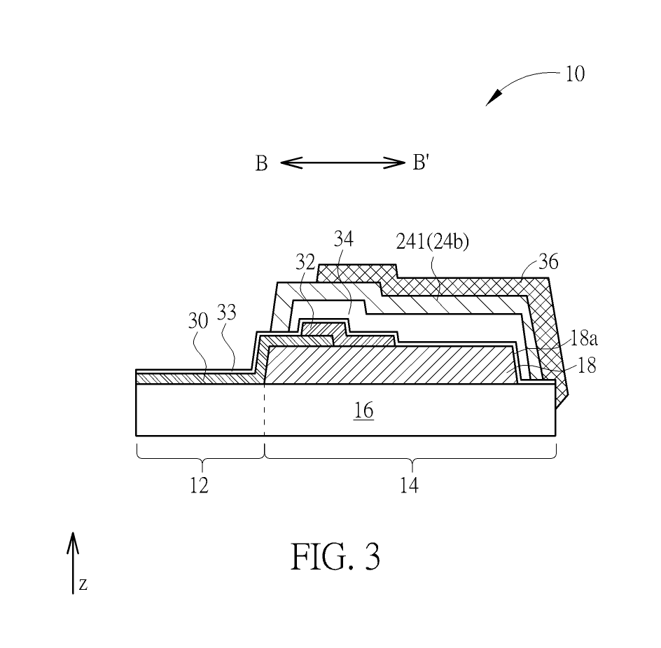

Referring to FIG. 3, FIG. 3 is a schematic diagram of the cross-sectional view of a touch panel according to the first variant embodiment of the first embodiment of the present invention, wherein FIG. 3 only shows the cross-sectional structure of the touch panel along the sectional line B-B′ in FIG. 1. In this variant embodiment, the outer frame layer 36 extends inwardly from the outer part of the peripheral region 14 to the inner part of the peripheral region 14, and therefore it partially overlaps the wire 32. In addition, the second portion 24b of the hole-filling layer 24 also extends inwardly to overlap the inner sidewall of the second function layer 34, such that the second portion 24b of the hole-filling layer 24 still provides the function to smooth the gradient of the inner part of the outer frame layer 36.

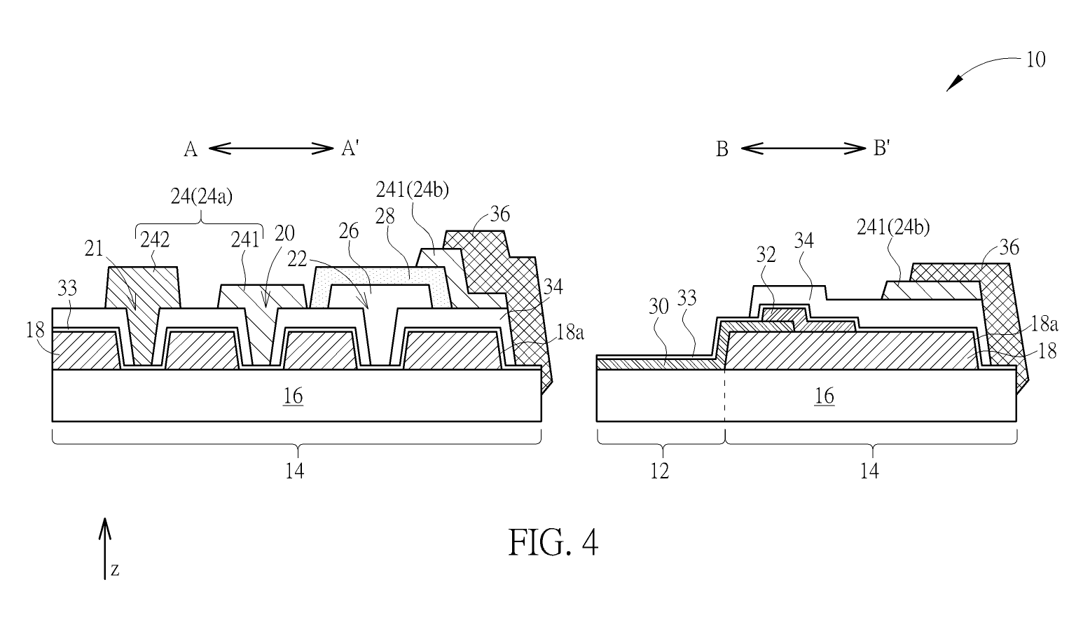

Refer to FIG. 4, FIG. 4 is a schematic diagram of the cross-sectional view of a touch panel according to the second variant embodiment of the first embodiment of the present invention, wherein FIG. 4 shows the cross-sectional structure of the touch panel along the sectional lines A-A′ and B-B′ in FIG. 1. This variant embodiment is different from the first embodiment in that the second portion 24b of the hole-filling layer 24 is disposed only on the top surface of the second function layer 34 but does not cover the outer sidewall of the function layer 34.

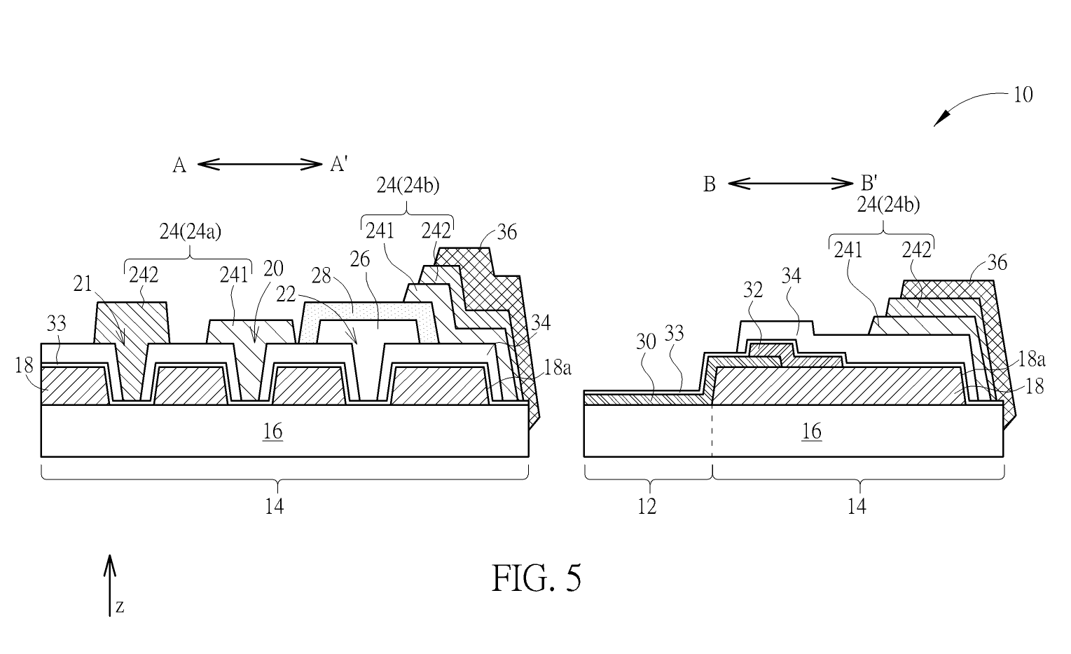

Referring to FIG. 5, FIG. 5 is a schematic diagram of the partial cross-sectional view of a touch panel according to the second embodiment of the present invention. This embodiment is different from the first embodiment in that the second portion 24b of the hole-filling layer 24 includes the first hole-filling layer 241 and also the second hole-filling layer 242, wherein the two are stepwise and sequentially disposed on the decoration layer 18 and partially overlap the decoration layer 18. Therefore, in the outer part of the peripheral region 14, there are totally three steps of layers from the back cover layer 28 to the outer frame layer 36, which are the first hole-filling layer 241, the second hole-filling layer 242, and the outer frame layer 36 to make the gradient more gentle and to further improve the height differences and the yield of the subsequent bonding process. Similarly, in other embodiments not illustrated, the step-shaped structure mentioned above can also be formed in the inner part of the peripheral region 14, determined by the range of the outer frame layer 36. Besides, the second portion 24b does not have to partially overlap the back cover layer 28 and it may only overlap the top of the decoration layer 18.

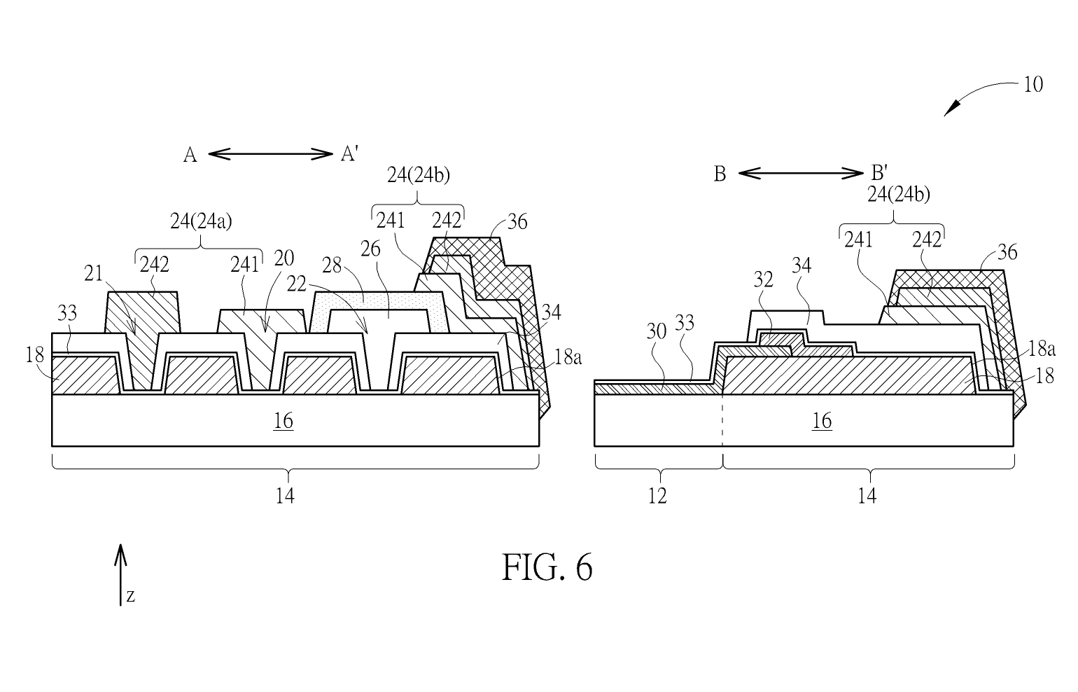

Referring to FIG. 6, FIG. 6 is a schematic diagram of the cross-sectional view of a touch panel according to a variant embodiment of the second embodiment of the present invention. In comparison with the second embodiment, the outer frame layer 36 of this variant embodiment extends inwardly from the outer edge of the peripheral region 14 to overlap the inner sidewall of the second hole-filling layer 242 of the second portion 24b of the hole-filling layer 24, which means the outer frame layer 36 covers the second hole-filling layer 242 of the second portion 24b in the vertical projection direction Z and overlaps its sidewall and surface.

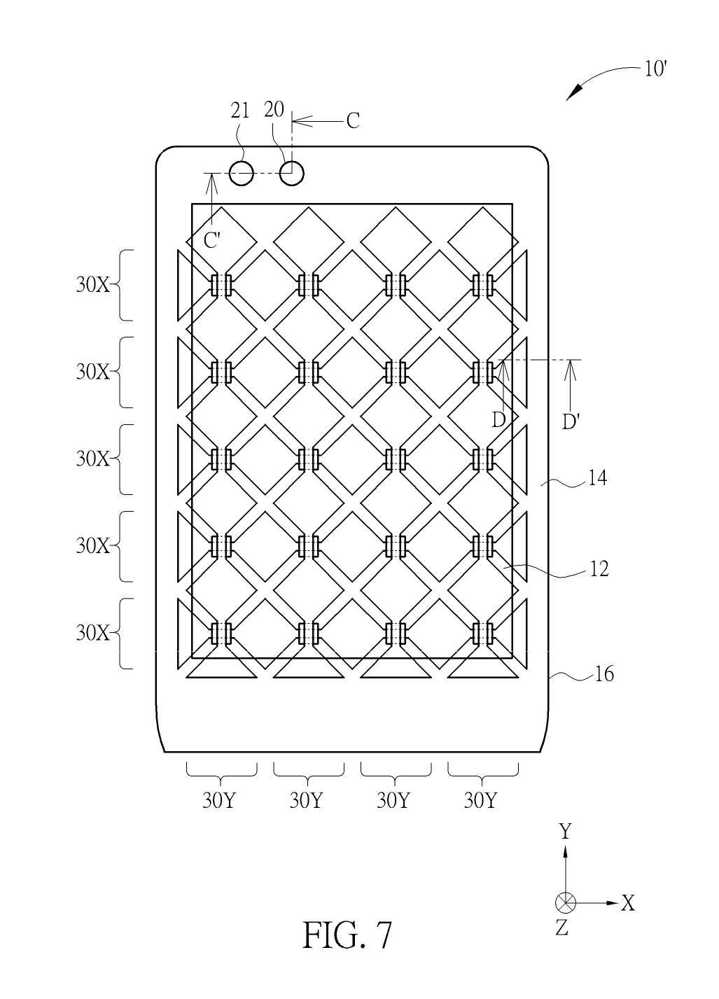

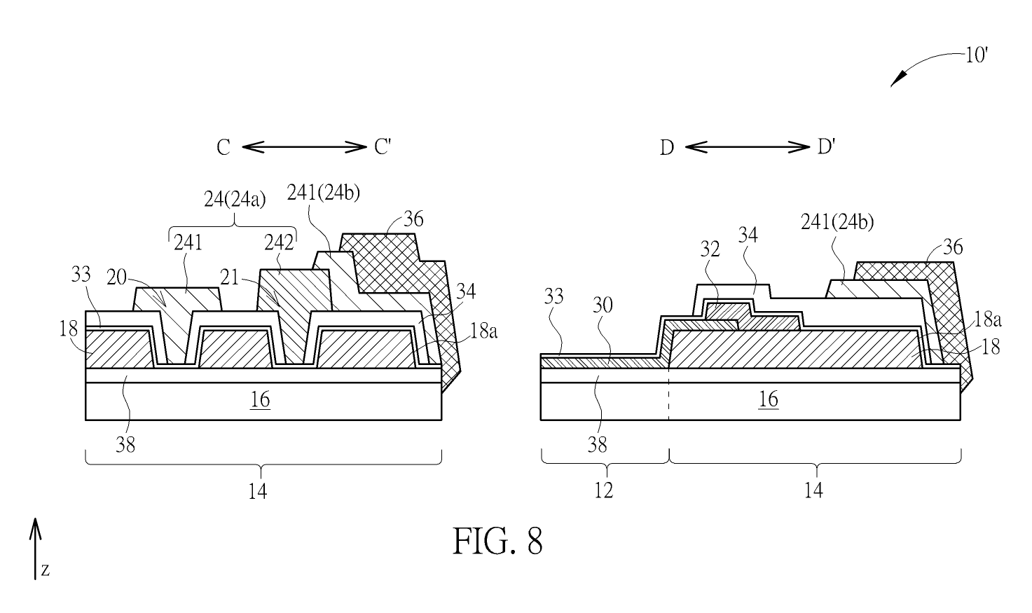

Referring to FIG. 7 and FIG. 8, FIG. 7 is a schematic diagram of the top view of a touch panel according to the third embodiment of the present invention, and FIG. 8 is a schematic diagram of the cross-sectional view of the touch panel shown in FIG. 7 along the sectional line C-C′ and the sectional line D-D′. In the touch panel 10′ in FIG. 7, the third function hole 22 in FIG. 1 is not illustrated. This embodiment is different from the first embodiment in that the second portion 24b of the hole-filling layer 24 is composed of the first hole-filling layer 241, and a portion of the first hole-filling layer 241 partially overlaps the second hole-filling layer 242 in the vertical projection direction Z, which is disposed between the outer frame layer 36 and the second hole-filling layer 242. In addition, the touch panel 10′ in FIG. 8 optionally includes a buffer layer 38 disposed on the surface of the substrate 16 and also disposed between the substrate 16 and the decoration layer 18. Similarly, in other embodiments not illustrated, the first hole-filing layer 241 of the second portion 24b does not have to overlap a portion of the second hole-filling layer 242 and may only solely overlap the top of the decoration layer 18. In addition, the step-shaped structure can also be formed in the inner part of the peripheral region 14, determined by the range of the outer frame layer 36.

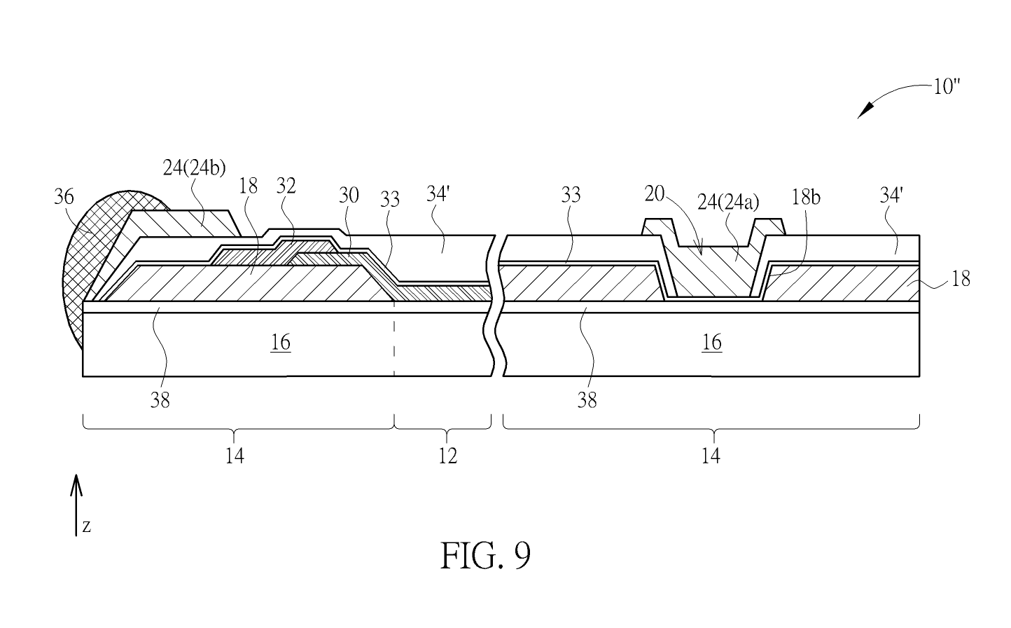

Referring to FIG. 9, FIG. 9 is a schematic diagram of the partial cross-sectional view of a touch panel according to the fourth embodiment of the present invention, wherein FIG. 9 only shows the first function hole 20. This embodiment is different from the previous embodiments in that the second function layer 34′ of the touch panel 10″ fully overlaps the decoration layer 18 and the touch sensing element 30 to provide protection for the elements on the surface of the touch panel 10″. The second portion 24b of the hole-filling layer 24 still partially overlaps the second function layer 34′ in the vertical projection direction Z, and the second function layer 34′ in this embodiment may have greater thickness, such as having a thickness of about 1 micrometer to about 3.5 micrometers, to provide effects of flattening the surface of the touch panel 10″ by the way of serving as a planarization layer. In addition, at the first function hole 20, the second function layer 34′ overlaps the sidewall 18b of the decoration layer 18 and exposes the buffer layer 38 disposed on the surface of the substrate 16. The first portion 24a of the hole-filling layer 24 is disposed at the first function hole 20 and partially overlaps the second function layer 34′, while the first function hole 20 is filled with the first portion 24a. In other embodiments, the touch panel 10″ may include two layers of hole-filling layers, respectively filling in different function holes and disposed sequentially on the second function layer 34′ and below the outer frame layer 36 from bottom to up in the outer part of the peripheral region 14 so as to further improve the height differences from the surface of the second function layer 34′ to the surface of the outer frame layer 36. The disposition and the relative positions of the two layers of the hole-filling layers mentioned above may be referred to FIG. 5 and are not repeated here. Besides, similarly, in other embodiment not illustrated, the step-shaped structure formed by the second portion 24b and the outer frame layer 36 may also be fabricated in the inner part of the peripheral region 14, determined by the range of the outer frame layer 36.

Although the second portion 24b in all the above embodiments is shown to cover the outer sidewall 18a of the decoration layer 18, it is not limited thereto. In other embodiments not illustrated, the second portion 24b may be solely disposed on top of the decoration layer 18 and not cover the sidewall of the decoration layer 18.

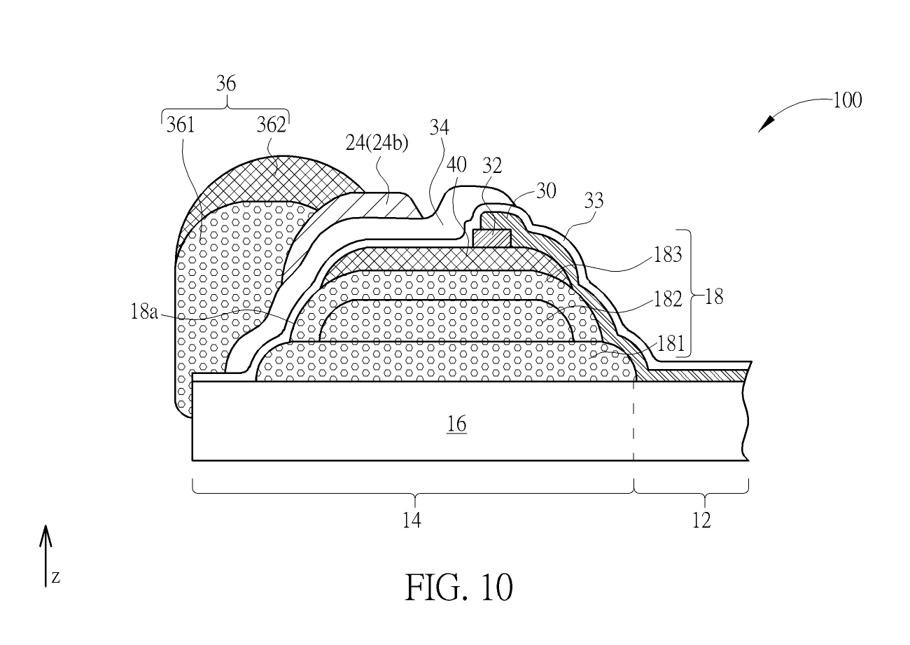

Referring to FIG. 10, FIG. 10 is a schematic diagram of the partial cross-sectional view of a touch panel according to the fifth embodiment of the present invention, wherein FIG. 10 does not show the region including the function hole(s). The structure of the elements and films or layers close to the function hole(s) may be referred to the previous embodiments and will not be repeated here. In this embodiment, the decoration layer 18 of the touch panel 100 is composed of material with lower OD, such as white ink. The decoration layer 18 includes the first decoration layer 181, the second decoration layer 182, and the third decoration layer 183 disposed sequentially on the surface of the substrate 16 from bottom to top. One of the functions of disposing multiple layers of decoration layer 18 is to increase the shielding performance of the decoration layer 18 in this embodiment. In addition, a shading layer 40 is included on the decoration layer 18. The hole-filling layer 24 partially overlaps the shading layer 40 and the decoration layer 18 in the vertical projection direction Z, and covers a portion of the outer sidewall 18a of the decoration layer 18. The touch panel 100 further includes an outer frame layer 36 disposed in the outer part of the peripheral region 14, partially overlapping the decoration layer 18, the shading layer 40, and the hole-filling layer 24 in the vertical projection direction Z, wherein the outer frame layer 36 includes a first outer frame layer 361 and a second outer frame layer 362 disposed sequentially on the surface of the substrate 16 from bottom to top. The first outer frame layer 361 may have the same color as the decoration layer 18, such as colors with lower OD values, and the OD value of the material of the second outer frame layer 362 is higher than the first outer frame layer 361 to increase the light-shading effect. In addition, similarly, in other embodiments not illustrated, a step-shaped structure formed by the second portion 24b and the outer frame layer 36 may also be formed in the inner part of the peripheral region 14, determined by the range of the outer frame layer 36.

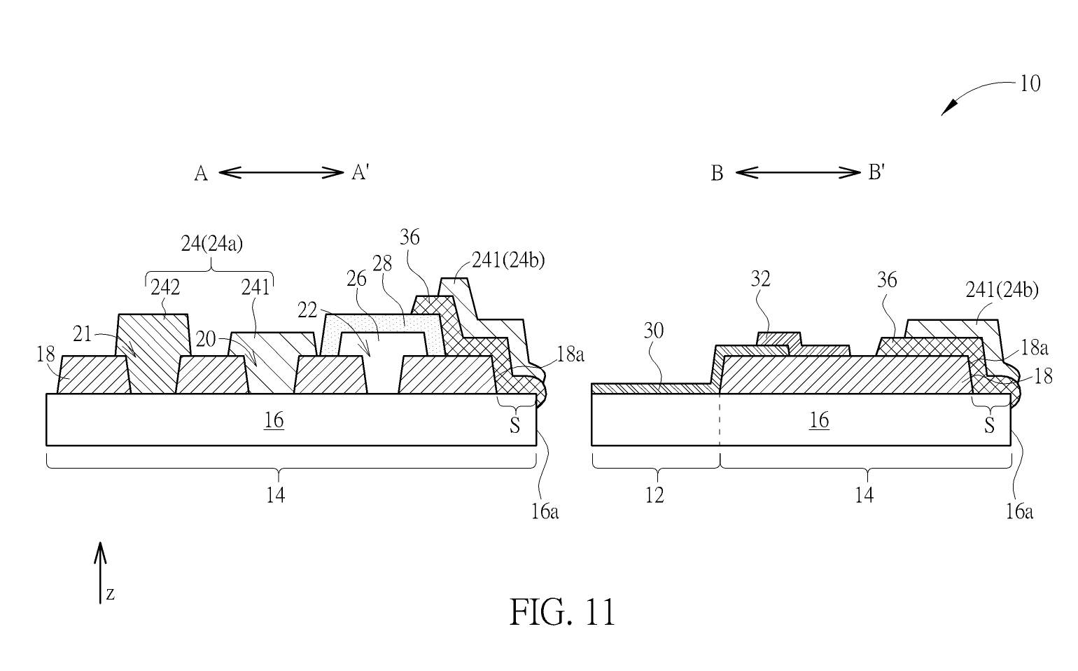

Referring to FIG. 11, FIG. 11 is a schematic diagram of the partial cross-sectional view of a touch panel according to the sixth embodiment of the present invention. Comparing to the first embodiment shown in FIG. 2, the touch panel 10 in this embodiment omits the first function layer 33 and the second function layer 34. Furthermore, in the outer part of the peripheral region 14, the disposition of the outer frame layer 36 and the second portion 24b of the hole-filling layer 24 (namely a portion of the first hole-filling layer 241) are exchanged. Although the outer frame layer 36 and the second portion 24b of the hole-filling layer 24 still overlap each other, the outer frame layer 36 overlaps on the surface of the decoration layer 18 and is directly in contact with the decoration layer 18. The first hole-filling layer 241 in the outer part of the peripheral region 14 is disposed on the surface of the outer frame layer 36, which means that the outer frame layer 36 is disposed between a portion of the first hole-filling layer 241 and the decoration layer 18 in the vertical projection direction Z, so that the second portion 24b of the hole-filling layer 24 and the outer frame layer 36 still form a step-shaped structure. In addition, a gap S exists between the outer edge of the decoration layer 18, namely the outer sidewall 18a of the decoration layer 18, and the side edge 16a of the substrate 16, and it is not overlapped by the decoration layer 18. The outer frame layer 36 and the second portion 24b of the hole-filling layer 24 both overlap the gap S. In this design, the first hole-filling layer 241 disposed in the outer part of the peripheral region 14 can provide the function to overlap the exposed edges, avoid light leakage, and protect the outer frame layer 36. The yield of bonding process may also be improved by the step-shaped structure. Moreover, all the materials of the hole-filling layer 24 in the previous embodiments can also be applied to this embodiment. In other similar embodiment, the second portion 24b of the hole-filling layer 24 may be composed of a portion of the second hole-filling layer 242 but not the first hole-filling layer 241. In other embodiments, the first hole-filling layer 241 and the second hole-filling layer 242 may be disposed on the outer frame layer 36 at the same time and the three form a step-shaped structure. In addition, in a variant embodiment, the touch panel 10 may still include a first function layer 33 and a second function layer 34 whose disposition may be referred to FIG. 2, and the outer frame layer 36 may include a plurality of layers.

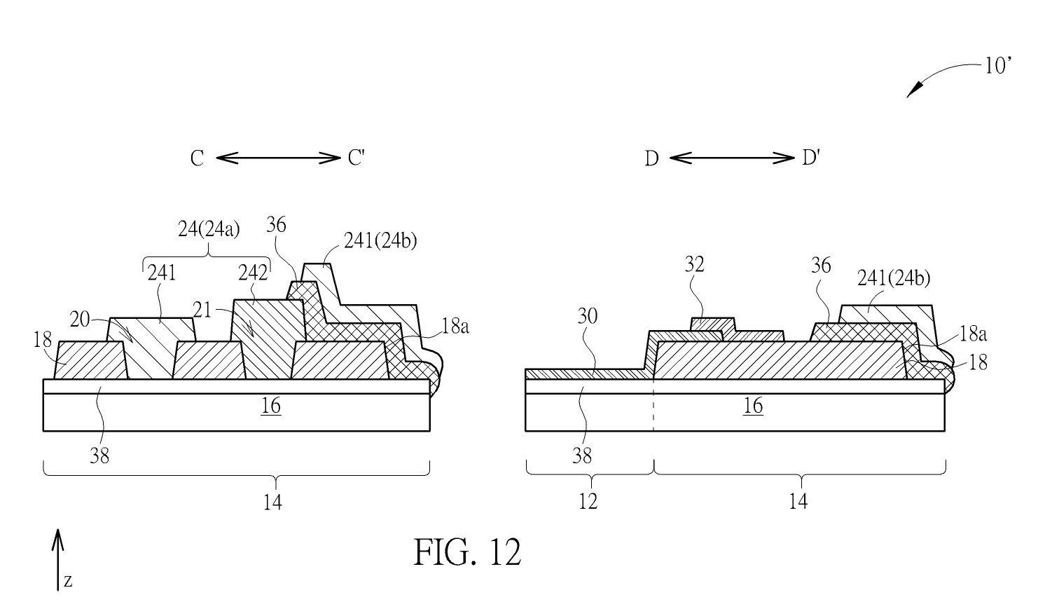

Referring to FIG. 12, FIG. 12 is a schematic diagram of the partial cross-sectional view of a touch panel according to the seventh embodiment of the present invention. Comparing to the third embodiment shown in FIG. 8, the touch panel 10′ in this embodiment omits the first function layer 33 and the second function layer 34, and the disposition of the outer frame layer 36 and the second portion 24b of the hole-filling layer 24 (namely a portion of the first hole-filling layer 241) in the outer part of the peripheral region 14 are exchanged. Similar to the previous embodiment, although the outer frame layer 36 and the second portion 24b of the hole-filling layer 24 still overlaps each other, the outer frame layer 36 is directly disposed and overlaps on the surface of the decoration layer 18 and directly contacts the decoration layer 18. And the first hole-filling layer 241 in the outer part of the peripheral region 14 is disposed on the surface of the outer frame layer 36, which means that the outer frame layer 36 is disposed between a portion of the first hole-filling layer 241 and the decoration layer 18 in the vertical projection direction Z. In addition, the outer frame layer 36 and the second portion 24b of the hole-filling layer 24 in this embodiment overlaps the gap S between the outer edge of the decoration layer 18 and the side edge 16a of the substrate 16. In other embodiments, the touch panel 10 may still include a first function layer 33 and a second function layer 34 and their disposition may be referred to FIG. 8.

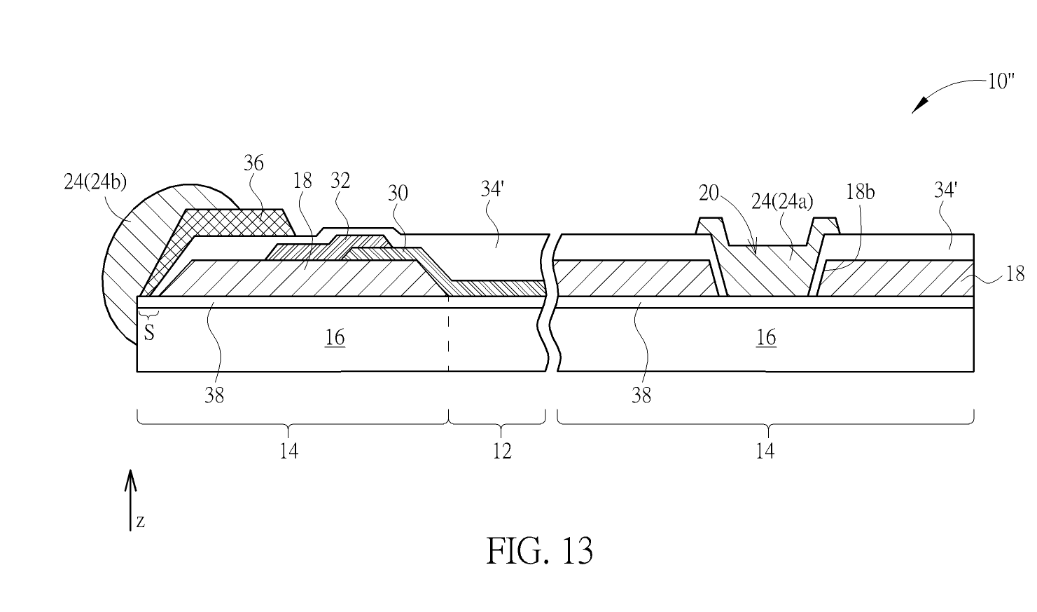

Referring to FIG. 13, FIG. 13 is a schematic diagram of the partial cross-sectional view of a touch panel according to the eighth embodiment of the present invention. Comparing to the fourth embodiment shown in FIG. 9, the disposition of the outer frame layer 36 and the second portion 24b of the hole-filling layer 24 (namely a portion of the first hole-filling layer 241) in the outer part of the peripheral region 14 of the touch panel 10″ in this embodiment are exchanged. Similar to the sixth embodiment, although the outer frame layer 36 and the second portion 24b of the hole-filling layer 24 still overlaps each other, the first hole-filling layer 241 in the outer part of the peripheral region is disposed on the surface of the outer frame layer 36, which means the outer frame layer 36 is disposed between a portion of the first hole-filling layer 241 and the decoration layer 18 in the vertical projection direction Z. In addition, the outer frame layer 36 and the second portion 24b of the hole-filling layer 24 overlaps the gap S disposed between the outer edge of the decoration layer 18 and the side edge 16a of the substrate 16.

In other embodiments of the present invention, the touch panel may be a two-substrate type touch panel. For example, the touch panel of the present invention may additionally include a touch sensing substrate disposed on the upper side of the substrate 16 mentioned above, and the touch sensing element 30 and the wire 32 are disposed on the surface of the touch sensing substrate instead of on the surface of the substrate 16 as in the embodiments previously described. When the touch panel of the present invention is a two-substrate type touch panel, the substrate 16 is regarded as the cover plate of the touch panel, and the cover plate and the touch sensing substrate may be respectively a glass substrate, a plastic substrate or a soft film. Therefore, the touch panel of the present invention can be applied to the case in which the touch sensing element and the hole-filling layer and the decoration layer are disposed on a substrate at the same time and the case in which they are disposed separately in different substrates. In the later case, the cover plate and the touch sensing substrate can respectively be rigid substrate or soft film, but not limited thereto. However, in some embodiments, they are both soft films and an additional rigid substrate may be optionally provided for protecting the soft films.

In addition, the relative position of the second portion of the hole-filling layer and the outer frame layer and the other films or layers in every embodiment of the present invention is not limited to the diagrams corresponding to the embodiments previously described. The variant embodiments of every embodiment may be referred to the variant embodiments of the first and the second embodiments as mentioned above. For example, the outer frame layer and the second portion of the hole-filling layer may both extend inwardly from the outer edge of the peripheral region to the inner edge of the peripheral region, the outer frame layer may extend inwardly to overlap a portion of the inner sidewall of the second portion of the hole-filling layer, or the second portion of the hole-filling layer is only disposed on top of the decoration layer but not covering the sidewall of the decoration layer, which will not be repeated here.

According to the preferred embodiments previously described of the present invention, the hole-filling layer of the touch panel of the present invention includes a first portion disposed at the function hole and the second portion disposed in the outer part or the inner part of the peripheral region. The second portion of the hole-filling layer can be used as a step between the surface layer of the substrate and the outer frame layer, or the outer frame layer can be used as a step between the surface layer of the substrate and the second portion of the hole-filling layer, to reduce the height difference between the inner part and outer part of the peripheral region and further improve the performance of the subsequent bonding process and reduce the bubbles caused by the bonding process. The hole-filling layer of the touch panel of the present invention can be, but not limited to, the ink layer or any layer used for filling the IR hole, the LED hole, the logo hole, or any function hole, or be the back cover ink layer. In addition, the first portion and the second portion of the hole-filling layer can be fabricated in the same process so that no extra additional production cost is needed to reach the effect of improving the yield of the touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel having a light transmission touch sensing region and a peripheral region disposed on at least one side of the light transmission touch sensing region, the touch panel comprising:
a decoration layer, disposed in the peripheral region and comprising at least one function hole;
a hole-filling layer, comprising:
a first portion, disposed at the function hole; and
a second portion, disposed in the peripheral region and overlapping at least one portion of the decoration layer;
an outer frame layer, disposed in the peripheral region and partially overlapping the second portion of the hole-filling layer; and
at least one touch sensing element, disposed in the light transmission touch sensing region.

2. The touch panel of claim 1, wherein the second portion of the hole-filling layer and the outer frame layer form a step-shaped structure.

3. The touch panel of claim 1, wherein the decoration layer comprises two function holes, and the hole-filling layer comprises:
a first hole-filling layer, one portion of the first hole-filling layer being filled into one of the function holes; and
a second hole-filling layer, one portion of the second hole-filling layer being filled into the other one of the function holes, and the first hole-filling layer and the second hole-filling layer being disposed sequentially to form a step-shaped structure on the decoration layer and partially overlapping the decoration layer.

4. The touch panel of claim 3, wherein the second portion of the second hole-filling layer partially overlaps the second portion of the first hole-filling layer, and the outer frame layer covers the second portion of the second hole-filling layer.

5. The touch panel of claim 1, wherein the decoration layer comprises two function holes, and the hole-filling layer comprises:
a first hole-filling layer, one portion of the first hole-filling layer being filled into one of the function holes; and
a second hole-filling layer, one portion of the second hole-filling layer being filled into the other one of the function holes, and one portion of the first hole-filling layer being disposed between the second hole-filling layer and the outer frame layer.

6. The touch panel of claim 1, further comprising a surface layer, one portion of the surface layer being disposed between the decoration layer and the second portion of the hole-filling layer, and the second portion of the hole-filling layer partially overlapping the surface layer.

7. The touch panel of claim 6, further comprising a back cover layer disposed between the surface layer and the second portion of the hole-filling layer.

8. The touch panel of claim 1, further comprising a function layer that partially overlaps the decoration layer, the second portion of the hole-filling layer overlapping the function layer.

9. The touch panel of claim 1, further comprising a function layer that fully overlaps the decoration layer and the touch sensing element, the second portion of the hole-filling layer partially overlapping the function layer.

10. The touch panel of claim 9, wherein the function layer is a planarization layer.

11. The touch panel of claim 1, wherein the decoration layer comprises a first decoration layer, a second decoration layer and a third decoration layer sequentially stacked from bottom to top.

12. The touch panel of claim 1, wherein the outer frame layer comprises a first outer frame layer and a second outer frame layer overlapping on top of the first outer frame layer, and an optical density of the second outer frame layer is higher than an optical density of the first outer frame layer.

13. The touch panel of claim 1, wherein the outer frame layer is disposed in an outer part of the peripheral region, and the second portion of the hole-filling layer is disposed in the outer part of the peripheral region.

14. The touch panel of claim 1, wherein the outer frame layer is disposed in an outer part of the peripheral region and extends inwardly to an inner part of the peripheral region, and the second portion of the hole-filling layer is disposed in the inner part of the peripheral region.

15. The touch panel of claim 1, wherein the second portion of the hole-filling layer covers one sidewall of the decoration layer.

16. The touch panel of claim 1, wherein the outer frame layer and the second portion of the hole-filling layer partially overlap each other, and the second portion is disposed between the decoration layer and the outer frame layer.

17. The touch panel of claim 1, wherein the outer frame layer overlaps a portion of the surface of the decoration layer, and the second portion of the hole-filling layer and the outer frame layer partially overlaps each other, and the outer frame layer is disposed between the second portion of the hole-filling layer and the decoration layer.

18. A touch panel having a light transmission touch sensing region and a peripheral region disposed on at least one side of the light transmission touch sensing region, the touch panel comprising:
a decoration layer, disposed in the peripheral region, the decoration layer comprising at least one function hole;
a hole-filling layer, comprising:
a first portion, disposed at the function hole; and
a second portion, disposed in the peripheral region and overlapping at least one portion of the decoration layer; and
an outer frame layer, disposed in the peripheral region and at least partially overlapping the decoration layer, the outer frame layer being disposed between the second portion of the hole-filling layer and the decoration layer in the vertical project direction.

19. The touch panel of claim 18, further comprising at least one touch sensing element disposed in the light transmission touch sensing region.

20. The touch panel of claim 18, wherein the second portion of the hole-filling layer and the outer frame layer form a step-shaped structure.

21. The touch panel of claim 18, wherein the decoration layer comprises two function holes, and the hole-filling layer comprises:
a first hole-filling layer, one portion of the first hole-filling layer being filled into one of the function holes; and
a second hole-filling layer, one portion of the second hole-filling layer being filled into the other one of the function holes.

22. The touch panel of claim 18, wherein the decoration layer comprises two function holes, and the hole-filling layer comprises:
a first hole-filling layer, one portion of the first hole-filling layer being filled into one of the function holes; and
a second hole-filling layer, one portion of the second hole-filling layer being filled into the other one of the function holes, and the outer frame layer being disposed between one portion of the second hole-filling layer and one portion of the first hole-filling layer.

23. The touch panel of claim 18, further comprising a surface layer, one portion of the surface layer being disposed between the decoration layer and the outer frame layer, and the outer frame layer partially overlapping the surface layer.

24. The touch panel of claim 23, further comprising a back cover layer disposed between the surface layer and the outer frame layer.

25. The touch panel of claim 18, further comprising a function layer at least partially overlapping the decoration layer, and the second portion of the hole-filling layer and the outer frame layer at least partially overlapping the function layer.

26. The touch panel of claim 25, wherein the function layer is a planarization layer.

27. The touch panel of claim 18, wherein the outer frame layer is disposed in an outer part of the peripheral region, and the second portion of the hole-filling layer is disposed in the outer part of the peripheral region.

28. The touch panel of claim 18, wherein the decoration layer is disposed on a surface of a substrate, a gap is between an outer edge of the decoration layer and an outer edge of the substrate, and the outer frame layer overlaps the gap.

29. The touch panel of claim 28, wherein the second portion of the hole-filling layer overlaps the gap.

30. The touch panel of claim 18, wherein a material of the hole-filling layer includes infrared transmission material.
